(19) United States
(12) Patent Application Publication
(10) Pub. No.: US 2020/0306853 A1
(43) Pub. Date: Oct. 1, 2020

(54) CONTROL DEVICE FOR WIRE ELECTRICAL DISCHARGE MACHINE, WIRE ELECTRICAL DISCHARGE MACHINE, AND DISPLAYING METHOD OF MACHINING INFORMATION

(71) Applicant: FANUC CORPORATION, Yamanashi (JP)

(72) Inventor: Riho KUBOTA, Yamanashi-ken (JP)

(21) Appl. No.: 16/834,306

(22) Filed: Mar. 30, 2020

(30) Foreign Application Priority Data
Apr. 1, 2019 (JP) 2019-069776

(51) Int. Cl. B23H 7/20; G06F 3/14; G06F 3/0482; G05B 19/4155

(52) U.S. Cl. CPC B23H 7/20; G06F 3/14; G05B 2219/45221; G05B 19/4155; G06F 3/0482

(57) ABSTRACT

A control device for a wire electrical discharge machine includes: a storage unit configured to store a machining program that causes the wire electrical discharge machine to machine a workpiece with a wire electrode and image information showing a machining path along which the wire electrode moves relative to the workpiece according to the machining program, in association with each other; and a display unit configured to, when the machining program stored in the storage unit is selected, display the image information associated with the selected machining program.

### CROSS-REFERENCE TO RELATED APPLICATION

This application is based upon and claims the benefit of priority from Japanese Patent Application No. 2019-069776 filed on Apr. 1, 2019, the contents of which are incorporated herein by reference.

### BACKGROUND OF THE INVENTION

### Field of the Invention

The present invention relates to a control device for a wire electrical discharge machine, a wire electrical discharge machine and a displaying method of machining information, in which deterioration of work efficiency can be suppressed in the checking of the contents of a machining program for the wire electrical discharge machine.

### Description of the Related Art

The wire electrode of a wire electrical discharge machine moves relative to a workpiece along a machining path during implementation of electrical discharge machining. The machining path is set in a program that is read and executed by the wire electrical discharge machine.

The above program is generally called a “machining program”. The machining program is stored in a control device provided in the wire electrical discharge machine. The control device here is, for example, a CNC.

### SUMMARY OF THE INVENTION

An operator who uses a wire electrical discharge machine sometimes wants to know a machining path before start of machining. In such a case, the operator refers to the machining program stored in the wire electrical discharge machine. Thus, the operator can recognize the file name and the program number set in the file before executing the machining.

However, it is not easy for the operator to grasp the machining path only by looking at the file name and the program number. When the machining program is executed, it is not impossible, but is troublesome, to visually confirm the machining path by the technique disclosed in, for example, Japanese Laid-Open Patent Publication No. 2007-183724. In particular, in this checking method, when the wire electrical discharge machine is executing another machining program, the machining being executed must be interrupted. This causes adverse effects on the productivity of the wire electrical discharge machine.

It is therefore an object of the present invention is to provide a control device for a wire electrical discharge machine, a wire electrical discharge machine, and a displaying method of machining information, with which the machining path can be easily confirmed.

One aspect of the present invention is a control device for a wire electrical discharge machine, the control device including: a storage unit configured to store a machining program that causes the wire electrical discharge machine to machine a workpiece with a wire electrode and image information showing a machining path along which the wire electrode moves relative to the workplace according to the machining program, in association with each other; and a display unit configured to, when the machining program stored in the storage unit is selected, display the image information associated with the selected machining program.

Another aspect of the present invention is a wire electrical discharge machine, which includes the above control device for a wire electrical discharge machine.

Still another aspect of the present invention is a displaying method of machining information, which includes: a storing step of storing, in a storage unit, image information showing a machining path along which a wire electrode of a wire electrical discharge machine relatively moves according to a machining program, in association with the machining program; and a displaying step of, when the machining program stored in the storage unit is selected, displaying the image information associated with the selected machining program.

According to the present invention, there is provided a control device for a wire electrical discharge machine, a wire electrical discharge machine, and a displaying method of machining information, with which the machining path can be easily confirmed.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an overall configuration diagram of a wire electrical discharge machine according to an embodiment;

FIG. 2 is a schematic configuration diagram of a control device according to the embodiment; and

FIG. 3 is a flowchart showing an example of a processing flow of the control device.

### DESCRIPTION OF THE PREFERRED EMBODIMENTS

Hereinafter, preferred embodiments of the present invention will be described in detail with reference to the accompanying drawings.

### [First Embodiment]

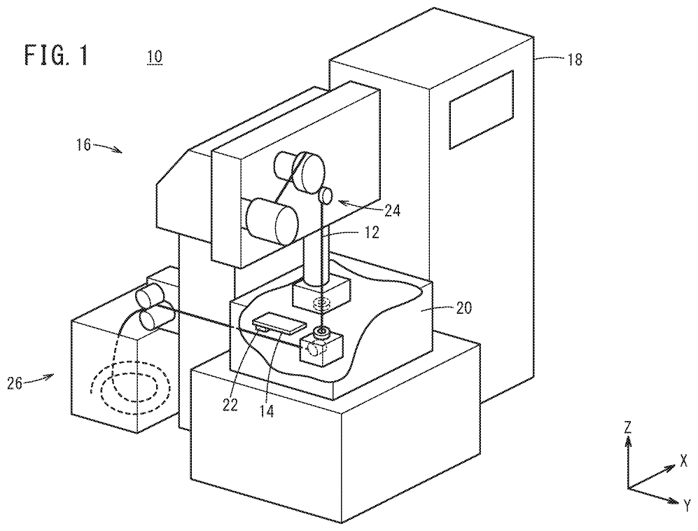

FIG. 1 is an overall configuration diagram of a wire electrical discharge machine 10 according to an embodiment. The directions of the X-axis, Y-axis, and Z-axis hereinbelow follow those shown in FIG. 1.

The wire electrical discharge machine 10 is a machine tool that includes a wire electrode 12 and performs electrical discharge machining on the workpiece 14 with the wire electrode 12. Hereinafter, the “wire electrical discharge machine 10” is also simply referred to as “processing machine 10”. “Electrical discharge machining” is also simply referred to as “machining”.

The processing machine 10 includes a main body 16 and a control device 18. The main body 16 includes a work-pan 20 in which dielectric working fluid is stored, the wire electrode 12 and a supporting unit 22 immersed in the working fluid in the work-pan 20, a supply system 24 and a collecting system 26 for supplying and collecting the wire electrode 12 fed toward a workpiece 14.

The supporting unit 22 is, for example, a table, and supports the workpiece 14 in the working fluid. Electrical discharge is generated between the wire electrode 12 and the workpiece 14 in the working fluid to thereby machine the workpiece 14. The supporting unit 22 moves in the work-pan 20 in the X-axis direction as an unillustrated X-axis servo motor rotates. Similarly, the supporting unit 22 moves in the work-pan 20 in the Y-axis direction as an unillustrated Y-axis servo motor rotates.

In the above main body 16 of the processing machine 10, as the supporting unit 22 supporting the workpiece 14 moves in the work-pan 20 in the X-axis direction and the Y-axis direction, the wire electrode 12 extending in the Z-axis direction moves relative to the workpiece 14. The processing machine 10 machines the workpiece 14 by causing the wire electrode 12 to move relative to the workpiece 14 while generating the electrical discharge.

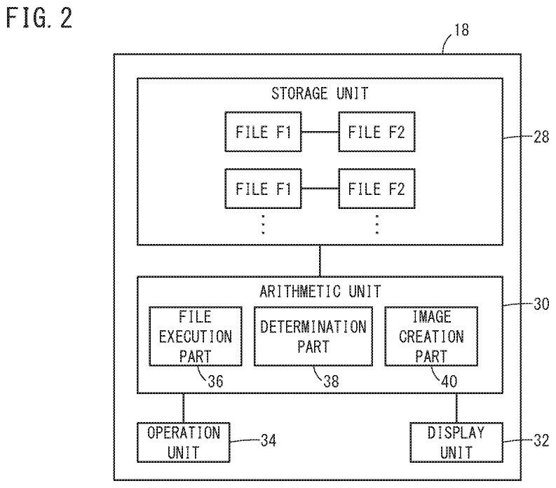

FIG. 2 is a schematic configuration diagram of the control device 18 according to the embodiment.

The control device 18 is a device for controlling the aforementioned main body 16, and is, for example, a CNC (Computer Numerical Control Unit). The control device 18 includes a storage unit 28, an arithmetic unit 30, a display unit 32 and an operation unit 34. These will be described in order.

The storage unit 28 is, for example, a memory. The storage unit 28 stores one or more data files (hereinafter, simply “files”). The operator can give arbitrary names to the respective files stored in the storage unit 28.

The storage unit 28 stores one or more files (file F1) each containing a machining program and a program number. The operator may arbitrarily set the name of the file F1. The “machining program” included in the file F1 is a program in which a path of the relative movement of the wire electrode 12 for machining the workpiece 14 is set. This path is also called “machining path”. The “program number” is a number that can be arbitrarily set for a machining program.

The storage unit 28 stores image information showing a machining path set by a machining program, in association with the machining program. The image information refers to, for example, a drawing or photograph in which a colored line is rendered along the machining path so as to allow visual confirmation of the machining path. The image information is stored in the storage unit 28 in association with the file F1, as another file (file F2) different from the file F1. The image information may be included in the same file F1 as the machining program.

The file F1 may include numerical parameters associated with the machining program. The numerical parameters include, for example, machining conditions, machining condition numbers, and a magnification ratio. The “machining condition” is a condition under which electrical discharge machining is performed, and includes, for example, parameters relating to the magnitude of the voltage applied to the wire electrode 12 when generating electrical discharge and a pause time of the voltage application. The “machining condition number” is a number that can be arbitrarily set for the machining condition. The “magnification ratio” refers to an enlargement (reduction) ratio of the machining path when the machining program is executed. The numerical parameters corresponding to the machining program in the file F1 may be included in another file associated with the file F1. For example, the machining condition, the machining condition number and the enlargement ratio may be included in the file F2 together with the image information. With this configuration, even if the machining program and the machining conditions are stored in separate files, the wire electrode 12 can perform machining by moving relative to the workpiece along the machining path of the machining program under the machining condition for the machining program.

The file F1 may include an offset amount and an offset number associated with the machining program. The “offset amount” is a distance between the wire electrode 12 and the machining path when the wire electrode 12 relatively moves along the machining path. The “offset number” is a number that can be arbitrarily set for the offset amount. Note that the offset amount and the offset number for the machining program of the file F1 may be included in another file associated with the file F1, similarly to the machining condition. For example, the offset amount and the offset number may be included in the file F2 together with the image information. With this configuration, even if the machining program and the offset amount are included in separate files, the wire electrode 12 can perform machining as keeping the offset amount for the machining program along the machining path of the machining program.

The arithmetic unit 30 is, for example, a processor having a processing capability. The arithmetic unit 30 includes a file execution part 36, a determination part 38, and an image creation part 10. The file execution part 36 reads and executes the file F1 from the storage unit 28. When files associated with the file F1 are stored in the storage unit 28, the file execution part 36 also reads and executes the files associated with the file F1 as appropriate. Examples of the files associated with the file F1 include a file related to the machining condition and the offset amount described above.

The determination part 38 determines whether image information associated with the machining program is stored in the storage unit 28 when the machining program is stored in the storage unit 28. When the machining program already stored in the storage unit 28 is updated, the determination part 38 may determine whether the image information associated with the updated machining program is stored in the storage unit 28.

When the determination part 38 determines that no image information is stored in the storage unit 28 in association with the machining program, the image creation part 40 creates image information based on the machining program. The creation of the image is performed by the file execution part 36 executing the machining program and collecting records during the execution. The image creation part 40 stores the created image information in the storage unit 28 in association with the machining program on which the image information has been created.

The display unit 32 is, for example, a screen display device having a liquid crystal screen. When a machining program is selected, the display unit 32 displays the file name of a file F1 including the selected machining program and the program number corresponding to the selected machining program on the screen. At this time, the display unit 32 may display the machining condition number and the offset number corresponding to the machining program of the file F1.

Also, when a machining program is selected, the display unit 32 of the present embodiment displays the image information associated with the selected machining program on the screen, together with the file name and the program number of the file F1. This makes it easy for the operator to grasp the machining path set in the selected machining program.

The operation unit 34 is, for example, a keyboard. The machining program can be selected by the operator designating a program number through the operation unit 34. Alternatively, the operator may select the machining program by selecting the file F1. At this time, the operator may select the file F1 by designating a file name, for example. In this case, the display unit 32 may display the file name of the selected file F1 and the program number in the same manner as described above. The display unit 32 may omit displaying one of the file name of the selected file F1 and the program number corresponding to the machining program included in the selected file F1.

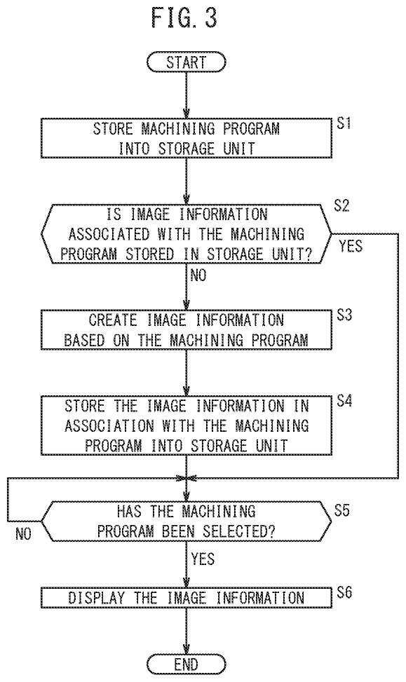

FIG. 3 is a flowchart showing an example of a processing flow of the control device 18.

Referring now to FIG. 3, a flow of processing related to a displaying method of machining information, which is performed in the control device 18, will be described. Note that the machining information refers to information related to machining performed by the processing machine 10.

The storage unit 28 stores a machining program specified by the operator, for example, in response to a request from the operator (step S1). Here, the machining program specified by the operator may be a machining program edited using the control device 18 or a machining program edited using a device different from the control device 18.

When the storage unit 28 stores the machining program, the determination part 38 determines whether or not image information is stored in the storage unit 28 in association with the machining program (step S2). Here, when it is determined that the image information is already stored in the storage unit 28 in association with the machining program (Step S2: YES), the control device 18 executes step S5 described later.

When the determination part 38 determines that no image information is stored in the storage unit 28 (step S2: NO), the image creation part 40 creates the image information based on the machining program (step S3: image creating step). In this embodiment, as described above, the file execution part 36 executes the machining program, and the image creation part 40 creates image information based on the record during the execution. Here, the file execution part 36 may suspend execution of the machining program for creating the image information until receipt of an instruction from the operator. This prevents the machining in execution from being interrupted when the processing machine 10 is machining a workpiece based on another machining program than the machining program stored at step S1.

The created image information is stored in the storage unit 28 in association with the machining program on which the image information is based (step S4: storing step). Here, as described above, the storage unit 28 may store the machining program and the image information as the same file F1, or may store the machining program and the image information as separate files F1 and F2. In the present embodiment, the latter is used.

By executing steps S1 to S4, the machining program and the image information associated with the machining program are stored in the storage unit 28 of the control device 18. In this state, the control device 18 determines whether or not the machining program stored in the storage unit 28 at step S1 has been selected (step S5). Here, as described above, the machining program may be selected by the operator specifying the program number or specifying the file name of the file F1.

When the machining program stored in the storage unit 28 at step S1 is selected (step S5: YES), the display unit 32 of the control device 18 displays the image information associated with the selected machining program on the screen (step S6: display step). At this time, as described above, the display unit 32 may display the file name, the program number, the machining condition number and/or the offset number on the screen as appropriate, together with the image information.

Thus, the operator can confirm machining information concerning the selected machining program, including image information indicating a machining path, on the display unit 32. With the confirmation, the operator can visually confirm the machining path, and hence easily grasp the machining path.

At step S6, the storage unit 28 displays the image information stored in advance, so that the operator does not need to actually execute the machining program in order to grasp the machining path. Therefore, according to the above method, it is not necessary to interrupt another machining program being executed at that time in order to confirm the machining path of a certain machining program. Thus, the operation efficiency of the operator can be improved.

### [Modified Examples]

Though the embodiment has been described as an example of the present invention, it is needless to say that various changes or improvements can be added to the embodiment. It is apparent from the description of the appended claims that embodiments with such changes or improvements can be incorporated in the technical scope of the invention.

For example, in the embodiment, the operator selects the machining program (file F1) by using the operation unit 34. When the processing machine 10 is set to automatically execute a plurality of machining programs in sequence, the display unit 32 may be configured to automatically and sequentially display machining information on machining programs to be executed subsequent to the machining program that is in execution.

### [Invention Obtained From the Embodiment]

The invention that can be grasped from the above-described embodiment and modified examples will be described below.

### <First Invention>

The first invention provides a control device (18) for a wire electrical discharge machine (10), the control device including: a storage unit (28) configured to store a machining program that causes the wire electrical discharge machine (10) to machine a workpiece (14) with a wire electrode (12) and image information showing a machining path along which the wire electrode (12) moves relative to the workpiece according to the machining program, in association with each other; and a display unit (32) configured to, when the machining program stored in the storage unit (28) is selected, display the image information associated with the selected machining program.

Thus, a control device (18) for a wire electrical discharge machine (10) that enables easy confirmation of the machining path can be provided.

The control device may further include an operation unit (34) configured to allow an operator to select the machining program, and the display unit (32) may be configured to display the image information associated with the machining program selected through the operation unit (34). This allows the operator to easily select a machining program.

The storage unit (28) may be configured to store a file (F1) in which the machining program and a program number are set in association with each other, and the display unit (32) may be configured to, when the file (F1) is selected, display at least one of the file name of the selected file (F1) and the program number together with the image information associated with the machining program of the selected file (F1). This enables the operator to easily recognize how the machining is performed when the selected machining program is executed.

The contents of the file (F1) may include an offset number associated with the machining program, and the display unit (32) may be configured to display the offset number of the file (F1) together with the image information of the file (F1) when the file (F1) is selected. This makes it easier for the operator to recognize how the machining is performed when the selected machining program is executed.

The storage unit (28) may be configured to store the file (F1) and the image information as separate files (F1, F2). With this configuration, the machining program and the image information can be handled as separate files (F1, F2).

The control device may further include: a determination part (38) configured to determine whether or not the image information associated with the machining program is stored in the storage unit (28); and an image creation part (40) configured to create the image information based on the machining program and store the created image information in the storage unit (28) if it is determined that the image information associated with the machining program is not stored in the storage unit (28). Thus, when there is no image information associated with the machining program, the image information can be created.

The determination part (38) may be configured to, at a time when the storage unit (28) has stored the machining program, determine whether or not the image information associated with the machining program is stored in the storage unit (28). By making a determination at the time when the storage unit (28) has stored the machining program, it is possible to create the image information associated with the machining program before the operator confirms it on the display unit (32).

### <Second Invention>

The second invention provides a wire electrical discharge machine (10) including the above-described control device (18) for the wire electrical discharge machine (10).

With this configuration, the wire electrical discharge machine (10) that enables easy confirmation of the machining path can be provided.

### <Third Invention>

The third invention provides a displaying method of machining information, including:
a storing step of storing, in a storage unit (28), image information showing a machining path along which a wire electrode (12) of a wire electrical discharge machine (10) relatively moves according to a machining program, in association with the machining program; and a displaying step of, when the machining program stored in the storage unit (28) is selected, displaying the image information associated with the selected machining program.

This provides a displaying method of machining information that enables the operator to easily check the machining path.

The displaying step may display the image information associated with the machining program selected by the operator of the wire electrical discharge machine (10). This allows the operator to easily select a machining program.

The storing step may store a file (F1) in which the machining program and a program number are set in association with each other, and the displaying step may, when the file (F1) is selected, display at least one of the file name of the selected file (F1) and the program number, together with the image information associated with the machining program of the selected file (F1). This enables the operator to easily recognize how the machining is performed when the selected machining program is executed.

The contents of the file (F1) may include an offset number associated with the machining program, and the displaying step may display the offset number of the file (F1) together with the image information of the file (F1) when the file (F1) is selected. This enables the operator to more easily recognize how the machining is performed when the selected machining program is executed.

The storing step may store the file (F1) and the image information as separate files (F1, F2). With this configuration, the machining program and the image information can be handled as separate files (F1, F2).

The displaying method may further include a determination step of determining whether or not the image information associated with the machining program is stored in the storage unit (28); and an image creating step of creating the image information based on the machining program and storing the created image information in the storage unit (28) if it is determined that the image information associated with the machining program is not stored in the storage unit (28). Thus, when there is no image information associated with the machining program, the image information can be created.

The determination step may be performed at a time when the storage unit (28) has stored the machining program. By making a determination at the time when the storage unit (28) has stored the machining program, it is possible to create the image information associated with the machining program before the displaying step.

What is claimed is:

1. A control device for a wire electrical discharge machine, comprising:
a storage unit configured to store a machining program that causes the wire electrical discharge machine to machine a workpiece with a wire electrode and image information showing a machining path along which the wire electrode moves relative to the workpiece according to the machining program, in association with each other; and
a display unit configured to, when the machining program stored in the storage unit is selected, display the image information associated with the selected machining program.

2. The control device for the wire electrical discharge machine according to claim 1, further comprising an operation unit configured to allow an operator to select the machining program, wherein the display unit is configured to display the image information associated with the machining program selected through the operation unit.

3. The control device for the wire electrical discharge machine according to claim 1, wherein:
the storage unit is configured to store a file in which the machining program and a program number are set in association with each other; and
the display unit is configured to, when the file is selected, display at least one of the file name of the selected file and the program number, together with the image information associated with the machining program of the selected file.

4. The control device for the wire electrical discharge machine according to claim 3, wherein:
contents of the file include an offset number associated with the machining program; and
the display unit is configured to display the offset number of the file together with the image information of the file when the file is selected.

5. The control device for the wire electrical discharge machine according to claim 3, wherein the storage unit is configured to store the file and the image information as separate files.

6. The control device for the wire electrical discharge machine according to claim 1, further comprising:
a determination part configured to determine whether or not the image information associated with the machining program is stored in the storage unit; and
an image creation part configured to create the image information based on the machining program and store the created image information in the storage unit if it is determined that the image information associated with the machining program is not stored in the storage unit.

7. The control device for the wire electrical discharge machine according to claim 6, wherein the determination part is configured to, at a time when the storage unit has stored the machining program, determine whether or not the image information associated with the machining program is stored in the storage unit.

8. A wire electrical discharge machine, comprising the control device for the wire electrical discharge machine according to claim 1.

9. A displaying method of machining information, comprising:
a storing step of storing, in a storage unit, image information showing a machining path along which a wire electrode of a wire electrical discharge machine relatively moves according to a machining program, in association with the machining program; and
a displaying step of, when the machining program stored in the storage unit is selected, displaying the image information associated with the selected machining program.

10. The displaying method of machining information according to claim 9, wherein the displaying step displays the image information associated with the machining program selected by an operator of the wire electrical discharge machine.

11. The displaying method of machining information according to claim 10, wherein:
the storing step stores a file in which the machining program and a program number are set in association with each other; and
when the file is selected, the displaying step displays at least one of the file name of the selected file and the program number, together with the image information associated with the machining program of the selected file.

12. The displaying method of machining information according to claim 11, wherein:
contents of the file include an offset number associated with the machining program; and
the displaying step displays the offset number of the file together with the image information of the file when the file is selected.

13. The displaying method of machining information according to claim 11, wherein the storing step stores the file and the image information as separate files.

14. The displaying method of machining information according to claim 9, further comprising:
a determination step of determining whether or not the image information associated with the machining program is stored in the storage unit; and
an image creating step of creating the image information based on the machining program and storing the created image information in the storage unit if it is determined that the image information associated with the machining program is not stored in the storage unit.

15. The displaying method of machining information according to claim 14, wherein the determination step is performed at a time when the storage unit has stored the machining program.
